(19) United States
(12) Patent Application Publication
(10) Pub. No.: US 2010/0112228 A1
(43) Pub. Date: May 6, 2010

(54) FLAME RETARDANT FOR WOOD APPLICATION

(76) Inventor: Oswaldo L. Diniz, Hudson, MA (US)

Correspondence Address: MESMER & DELEAULT, PLLC, 1 NEW HAMPSHIRE AVE., SUITE 125, PORTSMOUTH, NH, 03801, US

(21) Appl. No.: 12/566,970

(22) Filed: Sep. 25, 2009

(30) Foreign Application Priority Data
Sep. 26, 2008 (BR) PI0804145-8

(51) Int. Cl. C09D 5/18; C09K 21/04; B05D 1/36; B05D 1/28; B05D 1/02

(52) U.S. Cl. 427/402; 423/302; 106/18.16; 427/429; 427/427

(57) ABSTRACT

A flame retardant for wood application characterized as a fire retardant made of phosphorus ammonium polyphosphate, with the chemical formula (NH4) n+2PnO3n+1, that can be used in watery and not-watery applications, in flame retardant inks and latex inks, applied during ink's formularization, and later applied, through the coating process in the phase of finishing of the construction, where the coating can be applied by brush, coil, airless pistol or other conventional means, and based on its easy application it can be used in new construction and in building rehabilitation.

### BACKGROUND

1. Field of the Invention

The pioneer patent request is related to a FLAME RETARDANT FOR WOOD APPLICATION that has been developed to delay fire propagation, whereby the retardant can be applied in fire retardant inks or latex inks by the ink manufacturer during formularization, thus preventing later direct or increased application of the product.

2. Description of the Related Art

Materials appointed as “flame retardants” or “fire retardants” generally are substances that present more difficulty in starting combustion or, once the combustion process has been initiated, burn at a slower speed than other materials without the corresponding substance. That is, these terms do not mean necessarily that the retardant materials do not burn. These products act forming a thermal isolation barrier that delays the propagation of the flame. Different mechanisms for the formation of this barrier exist, but the most common of these is the formation of a micron-porous foaming layer by the product on the surface in which it is applied when submitted to heat (flames). This layer, being extremely porous, becomes responsible for the thermal isolation and, in a certain way, it also inhibits the formation of hirocarbonets smoke. Another form of actuation of these products is through the route alteration of inflammable product decomposition during fire exposition, which means transforming them into carbon graphite (which is fire resistant) and water. The released water boils and absorbs heat, thereby cooling the fire.

A fire retardant is, according to the definition used in Fire Security, an added substance or a treatment applied to a material in order to delay the fire ignition or to reduce the degree of development of the combustion.

There are various processes of fire retarding treatments and they can be classified generically as one of three types:

Those that are incorporated in the compost wooden products during production;

Those that are introduced, for sterilizer impregnation, after production, in solid wood or in plywood or other particle panels; and

Those that are applied after the installation of the products in wood, inks and varnishes.

We want to make two points to clarify some frequent false conclusions:

Fire retardants do not make wood non-flammable under any circumstances. There are products that are not fire retarding; products which do not increase the thermal load because they themselves do not heat-up, but they do not protect against, that is, they do not prevent the wood itself from heating.

Fire retardants have many formularizations and act in diverse ways, with the objective being to control the combustion, the propagation of the flames throughout wood surface and to diminish the substratum heat release, that is, to improve the degree of reaction to the fire of the wood:

They promote or facilitate carbonization;

They convert volatile gases into non-flammable gases such as water vapor and CO2;

They form a vitrified barrier to the surface;

They form an intumescent barrier to the surface;

They release free radicals that inhibit the combustion reaction.

When submitting the fire retardants to fire reaction assays in different substrata, we have an essential classification in the choice of the protection type.

The environment where the wood treated with fire retardants occurs has a great influence on the type of treatment and its formularization,

High degrees of humidity can affect the behavior of certain treatments and cause undesirable collateral effect such as reduction of the resistance, corrosion of the element settings, degradation and problems on painted surfaces (or in painting, i.e., future painting that one might want to do).

The application conditions also have to be well observed because the application in humid weather can lead to serious problems. In the impregnation process, the application of this type of protection has to be made before the production/assembly of the structures and/or the application of coatings. The fire reaction certification is related to the substratum, the fire retardant that is used, and to the conditions and process of impregnation based on wood hardness and degree of humidity.

The protection treatment uses processes and equipment normally used in the wood preservation in a vacuum sterilizer.

The protection process results from the fact that, because of the retardant action, the volatile gases that appear as a result of the wood heating is transformed into fire resistant gases such as water vapor and CO2 that prevent reaching the combustion temperature level and releasing free-radicals that inhibit combustion.

In the coating process fire retardants will normally be applied in the finishing phase of construction.

Among most commonly used fire retarding coatings there are the intumescent coatings for wood, particularly transparent varnishes.

The intumescent coating reacts with heat, increasing its volume, forming a carbonized layer that limits the development of the flame and the heat transmission, which hinders the wood in reaching combustion temperatures. These coatings can be treated with brush, coil, airless pistol or other conventional system.

Given the ease of application, they are protections that can be used in new construction and in building rehabilitation, but they are used normally on interiors.

The obtained degree of fire reaction—a reaction to a fire of M2 or M1, depends normally on the thickness of the coating.

Although all the presented conditions, where is highlighted the necessity of looking at the surrounding conditions during the application, there are products that can be used in exterior environments but they must be formulated especially for this end.

One may apply mechanical protection systems through coatings with isolating panels and by application of fiber grout system.

The protection of the wood, as has already been said, can be made by mechanical means, especially when there are no esthetic impositions. In this way the following solutions are offered:

Coating of the wood elements with calcium silicate panels that are non-inflammable and that also work as isolators and, with previously calculated thickness, can prevent the wood surface from reaching combustion temperature.

Coating of the wood elements with a fiber grout system. Also discussed is the concept that has been applied in many works and that is transmitted throughout this exposition.

One must remember that wood preservative products contain toxic substances used to preserve them and to protect them from the attack of organisms that consume wood (xylophages) and provoke its deterioration. The wood destroying organisms are mainly fungi (microorganisms) and insects such as termites, ants and maggots.

The preservant can be hydro soluble (soluble in water) and oil soluble. Among the hydro soluble ones, are mentioned:

CCA: Acid copper chromate, also called “Bolden Salt.” It is made up of copper, chromium and arsenic. The chromium provokes the fixation of the arsenic's copper in the wood. CCB is similar to CCA; it is made up of copper, chromium and boron. It is also known as “Wolman Salt.”

Both of these products are efficient and possess excellent fixation in the wood, promoting wood's coloration. The chromium is the impregnation vehicle. After a hexavalent is applied, it is transformed into a trivalent that is not health harmless. Among the oil soluble choices, creosote is the most important one. It is oily, dark in color, possessing a strong and characteristic odor. It is tar distilled, obtained by coal carbonization. It contains about 200 different substances, grouped in acid hydrocarbons and in tar bases, each one presenting a specific toxicity level to xylophages' organisms. It is non-corrosive and it possesses good leaching resistance. It also makes the wood waterproof. The use of creosote frequently relieves the need for the utilization of a solvent, but in some cases burnt oil is used to dilute it.

### DESCRIPTION

Thus, the present invention consists of a flame retardant for wood application, comprising a flame retardant made of phosphorus ammonium polyphosphate, with the chemistry formula (NH4) n+2PnO3n+1, that can be used in watery and not-watery applications, in flame retardant inks and latex inks, added in the ink during its formularization, and later applied, through the coating process in the phase of finishing of the construction, where the coating can be applied by brush, coil, airless pistol or other conventional means. Since it has an easy application it can be used in new construction and in buildings rehabilitation.

Based on the description above we can conclude that the method to prevent flames propagation inside motor vehicles is indeed an innovation, it does not belong to the techniques already in usage, and fits perfectly inside the criteria that fits the definition of a pioneer patent. Its claims are the following ones.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A flame retardant for wood application comprising phosphorus ammonium polyphosphate having the chemical formula (NH4) n+2PnO3n+1.

2. The flame retardant of claim 1 further comprising flame retardant ink.

3. The flame retardant of claim 1 further comprising latex ink.

4. A method of making a wood surface flame retardant comprising the steps of:
applying ink to a wood surface; followed by
applying phosphorus ammonium polyphosphate having the chemical formula (NH4) n+2PnO3n+1 over the ink.

5. The method of claim 4, wherein the ink is a flame retardant ink.

6. The method of claim 4, wherein the ink is a latex ink.

7. A method of making a wood surface flame retardant comprising the steps of:
combining phosphorus ammonium polyphosphate having the chemical formula (NH4) n+2PnO3n+1 with ink during the ink's formularization, thereby making a combination; followed by
applying the combination to a wood surface.

8. The method of claim 7, wherein the ink is a flame retardant ink.

9. The method of claim 7, wherein the ink is a latex ink.

10. The method of claim 7 wherein the combination is used in a watery application.

11. The method of claim 7 wherein the combination is used in a non-watery application.

12. The method of claim 7 wherein the applying step is performed using a brush.

13. The method of claim 7 wherein the applying step is performed using a coil.

14. The method of claim 7 wherein the applying step is performed using an airless pistol.
